(19) United States
(12) Patent Application Publication
(10) Pub. No.: US 2016/0098825 A1
(43) Pub. Date: Apr. 7, 2016

(54) FEATURE EXTRACTION METHOD AND SYSTEM FOR ADDITIVE MANUFACTURING

(71) Applicant: Sigma Labs, Inc., Santa Fe, NM (US)

(72) Inventors: Vivek R. Dave, Concord, NH (US); R. Bruce Madigan, Butte, MT (US); Mark J. Cola, Santa Fe, NM (US); Martin S. Piltch, Los Alamos, NM (US)

(21) Appl. No.: 14/870,914

(22) Filed: Sep. 30, 2015

Related U.S. Application Data
(60) Provisional application No. 62/059,948, filed on Oct. 5, 2014.

(51) Int. Cl. G06T 7/00; B22F 3/105; G06K 9/62; H04N 5/247; G06K 9/52; G06T 7/60

(52) U.S. Cl. CPC G06T 7/001; G06K 9/52; G06T 7/60; G06K 9/6201; G06T 7/0044; H04N 5/247; B22F 3/1055; G06K 2009/4666

(57) ABSTRACT

The present invention provides a feature extraction system that extracts geometrical features of a part using in-process data acquired during an additive manufacturing process. The geometric features are extracted by applying a number of image processing operations to images taken of a powder bed during the additive manufacturing process. In this way, both internal and external geometries of the part can be characterized. In some embodiments, geometric feature extraction can be used in conjunction with other part characterizing operations, such as for example, thermal characterization processes.

### CROSS-REFERENCES TO RELATED APPLICATIONS

This application claims priority under 35 USC 119(e) to U.S. Provisional Patent Application No. 62/059,948, filed on Oct. 5, 2014, and entitled “FEATURE EXTRACTION METHOD AND SYSTEM FOR ADDITIVE MANUFACTURING,” the disclosure of which is hereby incorporated by reference in its entirety and for all purposes. U.S. Non-Provisional patent application Ser. No. 14/832,691, filed on Aug. 21, 2015 and entitled “METHOD AND SYSTEM FOR MONITORING ADDITIVE MANUFACTURING PROCESSES,” is incorporated by reference in its entirety and for all purposes.

### BACKGROUND OF THE INVENTION

Additive manufacturing, or the sequential assembly or construction of a part through the combination of material addition and applied energy, takes on many forms and currently exists in many specific implementations and embodiments. Additive manufacturing can be carried out by using any of a number of various processes that involve the formation of a three dimensional part of virtually any shape. The various processes have in common the sintering, curing or melting of liquid, powdered or granular raw material, layer by layer using ultraviolet light, high powered laser, or electron beam, respectively. Unfortunately, established processes for determining a quality of a resulting part manufactured in this way are limited. Conventional quality assurance testing generally involves destruction of the part. While destructive testing is an accepted way of validating a part's quality, as it allows for close scrutiny of various internal features of the part, such tests cannot for obvious reasons be applied to a production part. Consequently, ways of non-destructively verifying the quality of a part produced by additive manufacturing is highly desired.

### SUMMARY OF THE INVENTION

The present invention relates generally to methods and systems for non-destructively characterizing the structural integrity and geometry of parts created by additive manufacturing processes. For example, some embodiments relate to quality assurance processes for monitoring the production of metal parts using additive manufacturing techniques. More specifically, embodiments relate to the extraction of geometric features from data which is acquired while an additive manufacturing process is in progress.

The described embodiments are related to a large subcategory of additive manufacturing, which involves using an energy source that takes the form of a moving region of intense thermal energy. In the event that this thermal energy causes physical melting of the added material, then these processes are known broadly as welding processes. In welding processes, the material, which is incrementally and sequentially added, is melted by the energy source in a manner similar to a fusion weld.

When the added material takes the form of layers of powder, after each incremental layer of powder material is sequentially added to the part being constructed, the heat source melts the incrementally added powder by welding regions of the powder layer creating a moving molten region, hereinafter referred to as the weld pool, so that upon solidification they become part of the previously sequentially added and melted and solidified layers below the new layer that includes the part being constructed. As additive machining processes can be lengthy and include any number of passes of the weld pool, it can be difficult to avoid situations in which slight variations in the weld pool or scan pattern of the laser cause defects to be formed within the part. In some cases, these defects can place the resulting part outside of acceptable parameters.

One way to measure and characterize the quality of the final part is to add one or more sensors to an additive manufacturing tool set that provide in-process measurements during the additive manufacturing process. The additional sensors can be configured to measure the actual deposited condition of the article as it is being formed. In this way, geometric features can be extracted which can indicate the presence or absence of possible thermally induced distortions or deformations. In some embodiments, the extracted geometric features can be used to make inferences about the geometrical properties of the article such as shape, size, texture, and other geometrical properties which can be important to the overall acceptability of the resulting part. To determine the part's overall acceptability the geometrical properties derived from the geometric features can be compared to the initial desired specification of the properties and attributes of the article.

In particular this application discloses an automated additive manufacturing apparatus for producing a part on a powder bed. The automated manufacturing apparatus includes the following: a heat source configured to apply energy to deposited layers of powder arranged on the powder bed; an image capture device configured to periodically capture layer images of deposited layers of powder on the powder bed; and a processor configured to apply image processing to each image to extract geometric features of the part for each layer, and to compare the geometric features to baseline data that includes tolerances associated with the extracted geometric features. The heat source applies energy to the deposited layers by scanning across each deposited layer of powder in a pattern defined by the processor that corresponds to a geometry of the part.

An additive manufacturing method is also disclosed and can include the following operations: capturing a baseline image of a build plate using an image capture device; depositing a layer of metal material on the build plate; melting a region of the layer of metal material to form a part being produced by the additive manufacturing method with a heat source that scans across the region of the layer of metal material to melt the region; capturing a sintered layer image that includes the melted region of the layer of metal material using the image capture device; continuing to deposit layers of metal, melt regions of each layer and capture sintered layer images until the additive manufacturing method is complete; processing and aggregating data from the sintered layer images to extract geometric features formed by the additive manufacturing method; and comparing the extracted geometric features of the part constructed by the additive manufacturing method with baseline data that includes design tolerances associated with the extracted geometric features to determine whether the extracted geometric features of the part meets the design tolerances.

An additive manufacturing method for producing a part is also disclosed and includes the following operations: depositing a layer of metal powder; sintering a portion of the layer of metal powder; capturing an image of the sintered portion of the layer of metal powder using an image capture device; repeating the depositing, sintering and capturing steps until the part is complete; processing the captured images to extract geometric features corresponding to the completed part; and comparing the extracted geometric features to baseline data to determine whether the extracted geometric features fall within design specifications for the part.

It should be noted that the aforementioned process is used throughout this specification for exemplary purposes only and the processes described herein could also be applied with some modification to other additive manufacturing processes including any of the following: selective heat sintering, selective laser sintering, direct metal laser sintering, selective laser melting, fused deposition modelling and stereo lithography.

### BRIEF DESCRIPTION OF THE DRAWINGS

The disclosure will be readily understood by the following detailed description in conjunction with the accompanying drawings, wherein like reference numerals designate like structural elements.

FIG. 1 shows an overview of processes for demonstrating compliance to design intent.

FIG. 2 shows a relation between design intent and metallurgical, mechanical and geometrical properties.

FIG. 3 shows a high level overview of in-process data and feature extraction for geometrical properties.

FIG. 4 shows a block diagram describing a calibration process.

FIG. 5 shows a block diagram illustrating a geometric feature extraction process.

FIG. 6 shows exemplary flat field image data.

FIG. 7 shows exemplary raw image data.

FIG. 8 shows exemplary corrected image data.

FIG. 9 shows a corrected image data pixel intensity plot.

FIG. 10 shows exemplary offset image data.

FIG. 11 shows an offset image data pixel intensity plot.

FIG. 12 shows exemplary absolute value processed image data.

FIG. 13 shows an absolute value processed data pixel intensity plot.

FIG. 14 shows exemplary smoothed image data.

FIG. 15 shows a smoothed data pixel intensity plot.

FIG. 16. shows exemplary normalized image data.

FIG. 17 shows a normalized data pixel intensity plot.

FIG. 18 shows exemplary binary black and white image data.

FIG. 19 shows a binary black and white data pixel intensity plot.

FIG. 20 shows exemplary edge detection image data.

FIG. 21 shows a two dimensional layer by layer comparison of as-built geometrical properties to desired design intent.

FIG. 22. Shows a three dimensional multilayer build up based on geometric feature extraction of each layer of an additive manufacturing process.

FIG. 23 shows a perspective views of an additive manufacturing system utilizing a scanning laser beam and multiple different types of sensors utilized to provide in-process measurements.

FIG. 24A is a flowchart illustrating a process for establishing a baseline parameter set for building a part according to an embodiment of the present invention.

FIG. 24B is a flowchart illustrating a process for classifying a quality of a production level part based upon the established baseline parameter set according to an embodiment of the present invention.

### DETAILED DESCRIPTION OF SPECIFIC EMBODIMENTS

Embodiments of the present invention relate to methods and systems for conducting quality assurance monitoring during additive manufacturing processes.

Additive manufacturing or the incremental and sequential assembly or construction of a part through the combination of material addition and applied energy, takes on many forms and currently exists in many specific implementations and embodiments.

3D printing or additive manufacturing is any of various processes for making a three dimensional part of virtually any shape from a 3D model or from an electronic data file derived from a scan of a model or from a 3D CAD rendering. The various processes have in common the sintering, curing or melting of liquid, powdered or granular raw material, layer by layer using ultraviolet light or a high power laser, or electron beam, respectively.

An electron beam process (EBF3) was originated by NASA Langley Research Laboratory. It uses solid wire as the feed stock in a vacuum environment as well as when possible, in zero gravity space capsules. The process is notable for its sparing use of raw material. A focused high power electron beam is translated and creates a melt pool on a metallic surface into which the wire raw material is fed under the guidance of a coded deposition path. It has been used to produce components in sizes from fractions of an inch to tens of feet, limited only by the size of the vacuum chamber and the amount and composition of the wire feedstock that is available.

Selective heat sintering (SHS) uses thermoplastic powders that are fused by a heated printhead. After each layer is fused, it is lowered by a moveable baseplate and a layer of fresh thermoplastic powder is replenished in preparation for the next traversal of the printhead.

Selective laser sintering (SLS) uses a high power laser to fuse thermoplastic powders, metal powders and ceramic powders. This is also a scanning technology where the laser path for each layer is derived from a 3D modeling program. During the construction process, the part is lowered by a moveable support by exactly one powder layer thickness to maintain the laser's focus on the plane of the powder.

Direct metal laser sintering (DMLS), nearly identical to SLS, has been used with nearly any metal or alloy.

Selective laser melting (SLM) has been used for titanium alloys, chromium/cobalt alloys, stainless steels and aluminum. Here, the material is not sintered but is completely melted using a high power laser to create fully dense components in a layer . . . wise fashion.

Fused deposition modelling (FDM), is an extrusion process where a heated nozzle melts and extrudes small beads of material that harden immediately as they trace out a pattern. The material is supplied as a thermoplastic filament or as a metal wire wound on a coil and unreeled through the supply nozzle. The nozzle position and flow is computer controlled in three dimensions.

One way of measuring and characterizing the quality of a metal part during one of the aforementioned additive manufacturing processes is to capture an image of a structure upon which the metal part is manufactured after each layer is formed. In additive manufacturing processes using powder beds, extracting geometric data from these images is difficult as contrast between sintered metal powder that forms the part and metal powder that does not undergo the sintering process tends to be quite low. One way to overcome this problem is to apply a series of image processing operations to each image. In this way, both exterior and interior features created by the additive manufacturing process can be fully characterized and compared to ensure compliance of the part with manufacturing tolerances.

Another way of measuring and characterizing the quality of a metal part built with an additive manufacturing process is to add a number of temperature characterizing sensors to an additive manufacturing tool set that monitor and characterize the heating and cooling that occurs during formation of each layer of the part. This monitoring and characterizing can be provided by sensors configured to precisely monitor a temperature of portions of each layer undergoing heating and cooling at any given time during the manufacturing operation. When a heating source along the lines of a laser produces the heat necessary to fuse each layer of added material, the heated portion of the layer can take the form of a weld pool, a size and temperature of which can be recorded and characterized by the sensors. Real-time or post-production analysis can be applied to the recorded data to determine a quality of each layer of the part. In some embodiments, recorded temperatures for each part can be compared and contrasted with temperature data recorded during the production of parts having acceptable material properties. In this way, a quality of the part can be determined based upon characterization of any temperature variations occurring during production of the part.

In some cases, data gathered during the aforementioned geometric and heat monitoring processes can be correlated to make a more detailed characterization of overall part quality. The heat data provides excellent performance in terms of determining material qualities of the part, and the geometric data ensures acceptable internal and external surface geometries are achieved. In some situations, when heat data indicates a potentially disqualifying defect in the part, geometric data can be used to either confirm the defect disqualifies the part as out of tolerances or to help to determine that the part is in fact within tolerances. In this way, in-process data gathered during the additive manufacturing process can be used to provide substantial insight into the overall quality of a part using optical data gathered during the additive manufacturing process.

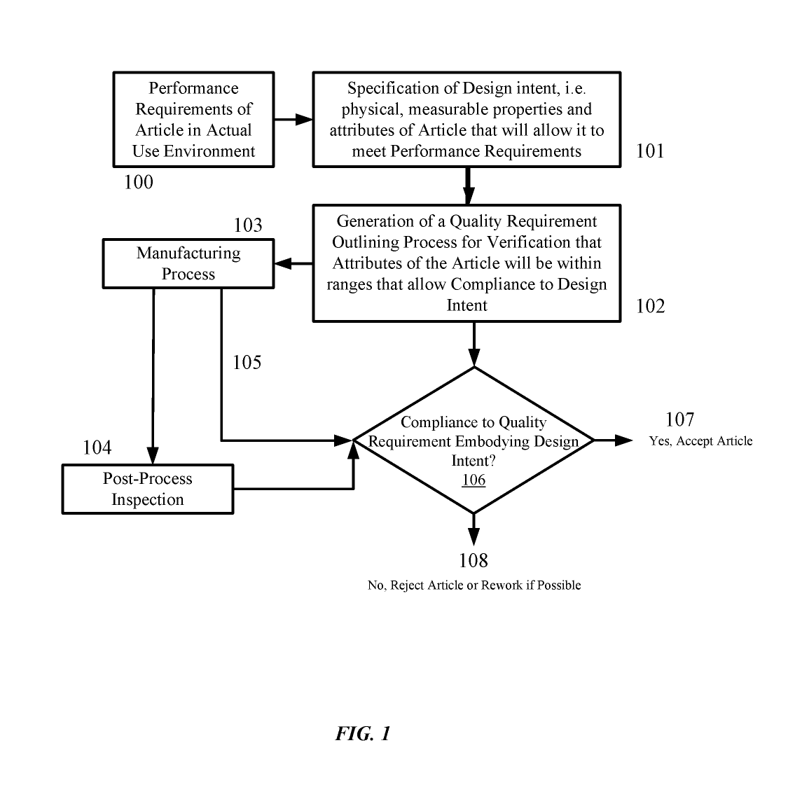

These and other embodiments are discussed below with reference to FIGS. 1-24B; however, those skilled in the art will readily appreciate that the detailed description given herein with respect to these figures is for explanatory purposes only and should not be construed as limiting.

For any manufacturing process, FIG. 1 shows the relationship between design intent, the manufacturing process, and verification of design intent. The ultimate definition of quality or acceptability any manufactured article is the Performance Requirements 100 of that article in its end use environment. For example, an automobile must have certain performance characteristics and metrics such as speed, ability to safety withstand a crash, fuel economy, etc. These Performance Requirements 100 are generally not directly linked to a specific part or article being manufactured, but rather are attributes of the final system or article in its end use environment. Therefore to generate a set of attributes and features that are measurable, the Design Intent 101 is specified. The Design Intent 101 is defined as the most general set of physical properties and attributes of an article that are measurable and which when proven to meet certain limit values or ranges of values will allow the manufactured article to meet the Performance Requirement 100. The Design Intent 101 is used to derive a Quality Requirement 102. The Quality Requirement 102 is the sum total of all processes, methods, and techniques by which the physical attributes of the article as specified in the Design Intent 101 will be measured and will be validated as being within certain ranges of values or achieving certain limit values so that the Design Intent 101 can be met. The next step in the process is that the actual Manufacturing Process 103 will be conducted so that the article can be manufactured. For the purposes of this invention, the Manufacturing Process is an additive manufacturing process, but FIG. 1 applies quite generally and is not limited to simply additive manufacturing processes. In most Manufacturing Processes 103, the means of measurement of the physical features and attributes as described in the Design Intent 101 and specified in the Quality Requirement 102 involves one or more Post Process Inspection steps 104. Alternatively or additional, and as is described in detail in this present invention, there can be in-process data 105 gathered continuously, intermittently, or at discrete intermediate states during the Manufacturing Process 103. Regardless of whether post-process inspection and/or in-process data collection are utilized, a Verification and Validation of Objective Compliance 106 must be established such that the post-process and/or in-process data are analyzed to determine whether the Design Intent 101 is being met. Therefore, FIG. 1 is the most general and generic framework showing how data gathered during Post Process Inspection 104 and/or In-Process Data 105 may be used to validate and verify objective compliance 106 with Design Intent 101.

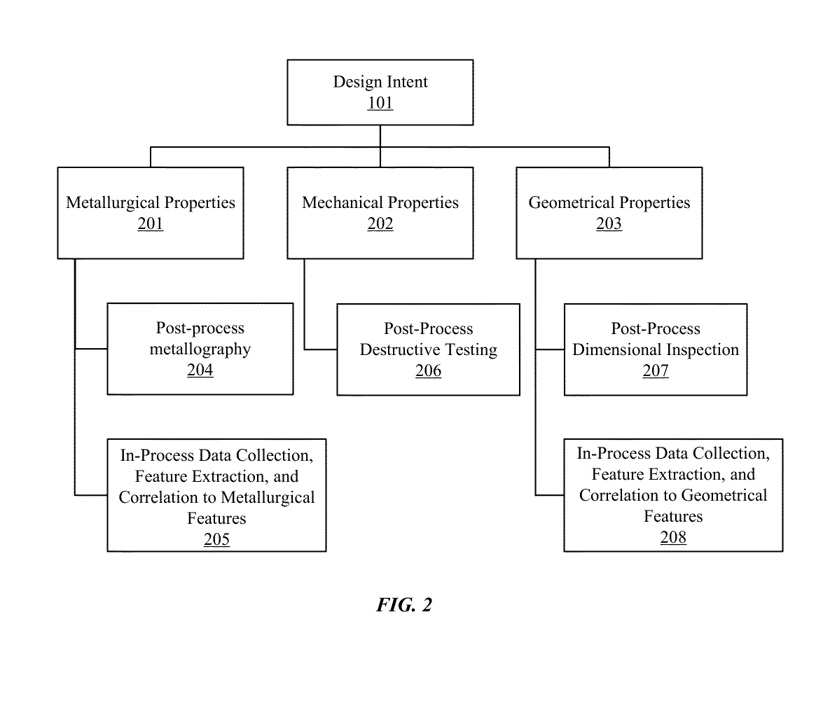

Now coming to additive manufacturing processes more specifically, there are various types of features and attributes that could constitute Design Intent 101 as well as some of the available means, methods and specification that could be specified in the Quality Requirements 102. This is outlined in FIG. 2. The Design Intent 101 is quantified by one of three general categories. First, the metallurgical properties 201 specify such quantities as grain size, composition precipitate structure, defect structure, and other microstructural features and attributes which characterize the structure of the material which comprises the manufactured article. The second category of properties is the set of mechanical properties 202. These could include, but are not limited to, such quantities as elastic properties and moduli, static yield strength, elongation and ductility, low cycle fatigue life, high cycle fatigue life, thermo mechanical fatigue life, crack growth rates under various loading conditions, creep and rupture properties, and other mechanical performance criteria under specialized loading conditions. The third category of properties is the set of geometrical properties 203. These could include shape, size, and texture among other geometrical properties.

Now coming to the various methods of measuring, validating and verifying the three categories of properties described above, there are destructive and non-destructive methods, as well as inprocess and postprocess methods. For example, in the evaluation of metallurgical properties 201, the nine most common methods involve the use of destructive evaluation techniques based on Metallography 204, or the microscope analysis of material structure. Alternatively, it is possible to use an inprocess approach 205. In this in-process approach 205, data from the additive manufacturing process is collected in-situ either continuously, intermittently, or at specific discrete intermediate states during the manufacture of the Article. Then features are extracted from this in-process data. The extracted features are then further correlated to microstructural features, and the ability of the in-process features to predict the corresponding microstructural features is validated and verified. Once this validation and verification is completed, then the in-process approach 205 can become predictive of metallurgical properties 201. The methods for testing and evaluating Mechanical Properties 202 usually involve destructive methods of Post-Process Destructive Mechanical Testing 206. Such methods involve a wide variety of testing methods and equipment at a wide range of strain rates, loading rates, and thermal conditions.

Finally coming to the methods and techniques for evaluating the Geometrical properties 203, the most common is the use of Post-Process Dimensional Inspection 207. This could be accomplished using a variety of measurement instruments, which could be simple gages, contact geometrical measurement machines such as CMMs—coordinate measurement machines, or non destructive geometric measurement methods such as CAT scanning—Computer Aided Tomography, or various optical scanning techniques which are also non-contact. Alternatively there is a body of techniques which is the subject of this present invention, namely in-process characterization of geometrical properties 203. In such inprocess characterization, first data is collected from a variety of sensors. Then features are extracted from this data which can be correlated to the Geometrical properties 203 of the Article. The data collected and the associated features extracted may be collected continuously, intermittently, or at specific discrete intermediate states occurring during the manufacture of the article. Lastly, there is a verification and validation step in which inprocess data 208 is compared to post-process dimensional inspection data 207 to verify that the in-process data is capable of verifying the Geometrical Properties 203 correspond to Design Intent 101.

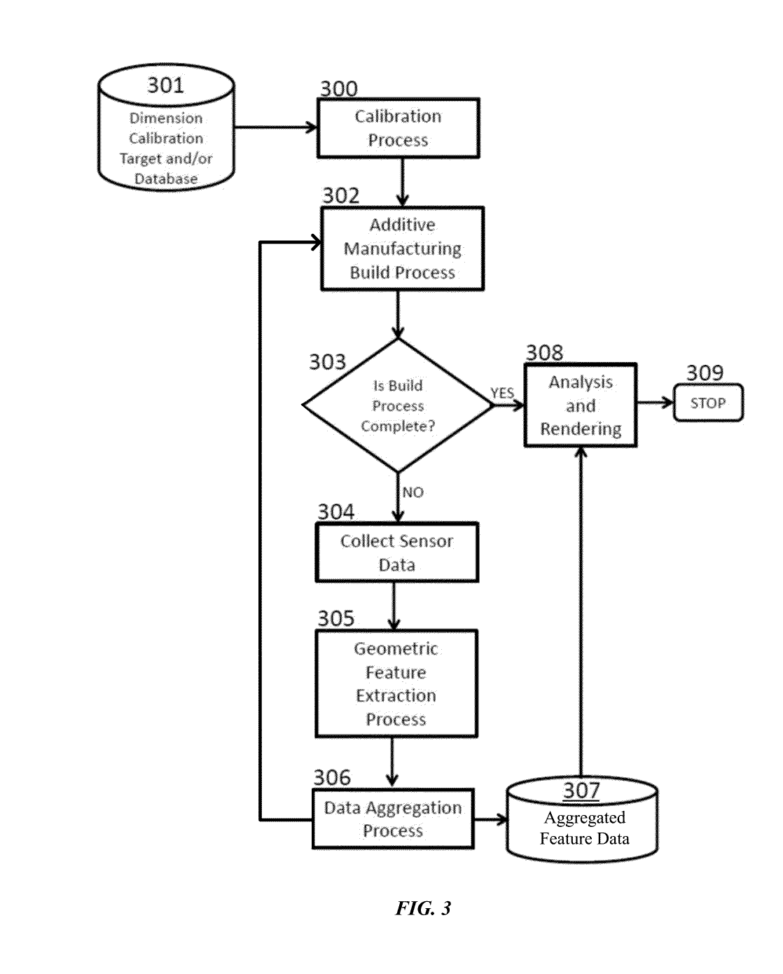

FIG. 3 explains the system and means by which in-process data acquired during an additive manufacturing process could be used to extract geometric features which can be correlated to geometrical properties of an article being manufactured at a high level and subsequent Figures will further elucidate the concepts embodied. The first step is the Calibration Process 300. This process involves the use of Dimension Calibration Targets and/or Database 301. These are either artifacts with precisely known dimensions that have been measured by post-process means, or the data from such inspections which is stored and formatted in a manner that will allow direct comparison with the in-process data which is to be collected. After the Calibration Process 300 is performed, it is then possible to collect in-process data from the actual additive manufacturing build process 302. However before collecting data at any given time interval or discrete state of the additive manufacturing build process 302, a Decision 303 must be made as to whether or not the build process is complete, i.e. is the article being built complete or not. If the process is not complete and there is still scope to collect further data, then In-Process Data 304 is collected on the additive manufacturing build process 302 with a variety of sensors. For example, these sensors could take the form of optical sensors. As a further example, the In-Process Data 304 could be image data that is created from a variety of optical devices such as, image or video capture devices along the lines of but not limited to: cameras, charged coupled devices (CCDs), CCD arrays, video cameras, optical scanners, line scanners, area scanners, confocal optical devices, optical devices capable of generating an image based on infrared detection, optical devices capable of generating an image based on laser illumination, photodiodes, and photodiode arrays.

Once In-Process Data 304 has been collected or while In-Process Data 304 is being collected, a Geometric Features Extraction Process 305 can begin. The features extracted during this process are those features that correlate to specific geometrical properties of the article being manufacturing such as, but not limited to, size, shape, and texture. After the geometric features are extracted from the In-Process Data 304, then there is a Data Aggregation Process 306 which combines the feature data with other data from the machine and from spatial reference frames. For example, this kind of Data Aggregation 306 could include, but is not limited to, correlation between the Geometric Features 305 and the location and spatial coordinate information about the article such as x-y-z location in the reference frame of the Article being manufactured by the additive manufacturing build process 302. The Data Aggregation Process 306 then generates another database, namely a database of Aggregated Feature Data 307. The Overall Process is at this point repeated, and the decision 303 regarding whether the build is complete is once again invoked. Once the additive manufacturing process 302 is complete, then an Analysis and Rendering Process 308 is invoked. The purpose of this Analysis and Rendering Process 308 is to put Aggregated Geometric Feature Data in the database of Aggregated Feature Data 307 into a visual format that is useful to the end user or engineer. Such examples of the Rendering Process 308 could include, but are not limited to: a mapping of the Aggregated Feature Data 307 onto a geometric model of the article being manufactured, or such mappings and/or comparisons performed on a specific layer or reference plane that intersects the solid model of the article being manufactured. The purpose of such comparisons are to see if the geometrical properties as represented by Aggregated Feature Data 307 are within specified ranges so that the Design Intent 101 is met. Finally, after the Analysis and Rendering 308 is completed, the overall means and systems of Feature Extraction come to a stop 309 and the data is available for use by the end-user.

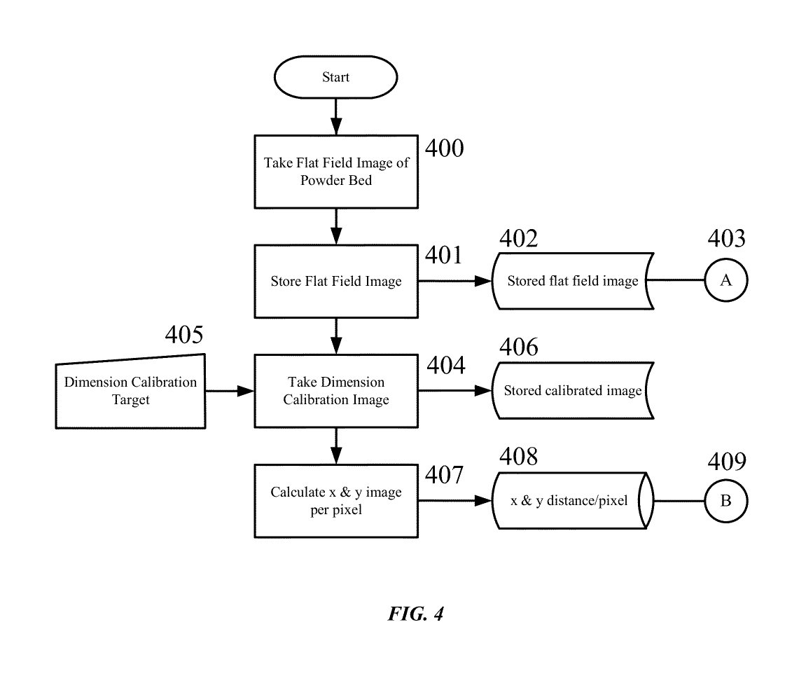

FIG. 4 further expands upon the processes enumerated in FIG. 3 and describes each in greater detail. FIG. 4 shows the Calibration Process 300 in more detail and as it would be applied to an additive manufacturing process including a powder bed process in which material is added by sequential layers of powder on a bed of powder, and where portions of each sequential layer are sequentially sintered with a heat source layer by layer to manufacture an article. At block 400, a flat field image is taken of the powder bed. The flat field image is taken after the first powder layer has just been applied but before the heat source has started to fuse the next layer of the article being manufactured. At block 402, the flat field image is stored. This stored image is saved to be used as input A, which is represented by block 403. Input A is used in the feature extraction process which will be described later in conjunction with FIG. 5. At block 404, a calibration image is taken of a dimension calibration target, represented in block 405. The dimension calibration target can have known dimensions, which have been verified through independent means. At block 406, the calibration image is stored for further analysis. At block 407, based on the known dimensions of the dimension calibration target and the stored calibration image, the X&Y pixel distances of the powder bed are calculated and the X&Y distance per pixel 408 is stored as a key set of parameters (Input B), which is represented by block 409. Input B is also used in the feature extraction process.

In FIG. 5, additional details of the Geometric Feature Extraction Process are provided by way of a concrete example. First, Input A, the stored Flat Field image data of the powder bed without any sintered material, is brought back into the analysis. Then at block 501 the raw image data gathered at any intermediate state during the additive manufacturing process is divided by the stored Flat Field image data. At block 502, the image data thus processed at block 501 is shifted so that there is a zero offset. At block 503, the shifted data is further transformed by taking the absolute value of the shifted data, i.e. transforming negative values to corresponding positive values. At block 504, the data is smoothed by a noise removal operation. The noise removal operation can take many forms including but not limited to a near neighbor noise reduction techniques called Gaussian Blur. At block 505, the smoothed data is normalized so that its maximum value is 1. Therefore the entire data field now occupies the interval [0,1]. At block 506, the normalized data is converted to pure black and white data, i.e. all gray scale intermediate values are converted to either white or black. At block 507, the black and white data is further processed by filling in any gaps which may have occurred as a result of the black and white conversion. At block 508, the filled in data 507 is further subjected to edge detection algorithms. At block 509, the edges that have been detected are scaled and put into real dimensional units. This is accomplished through the assistance of Input B, the previously stored X&Y distance per pixel scaling factors generated during the calibration process. In this way, the Geometric Feature Extraction is accomplished.

To even still further elucidate the result of the Geometric Feature Extraction means and systems outlined in FIG. 5, it is instructive to look at specific sub-processes and their effect on the feature data as well as the effect it has on the specific images as they are subjected to the various geometric feature extraction processes as elucidated in FIG. 5. The calibration process as outlined in FIG. 4 provides Input B, a set of scaling data that can be represented by:

i. scale_x=x calibration_in_mm/px

ii. scale_y=y calibration_in_mm/px

iii. scale_z=z calibration in mm/layer (1)

Where: scale_x is the scaling factor in the x-dimension, scale_y is the scaling factor in the y-dimension, scale_z is the scaling factor in the z-direction, x_calibration_in_mm/px is the numerical value of scale_x in units of millimeter per pixel, y_calibration_in_mm/px is the numerical value of scale_y in units of millimeters per pixel, and z_calibration_in_mm/layer is the numerical value of scale_z in units of millimeter per layer of powder deposited.

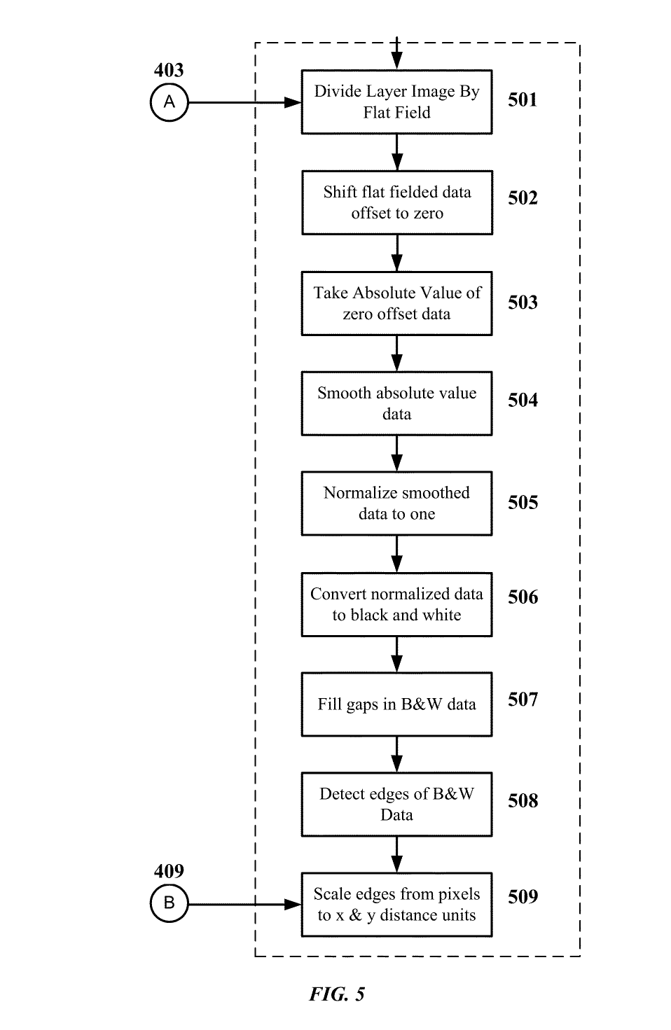

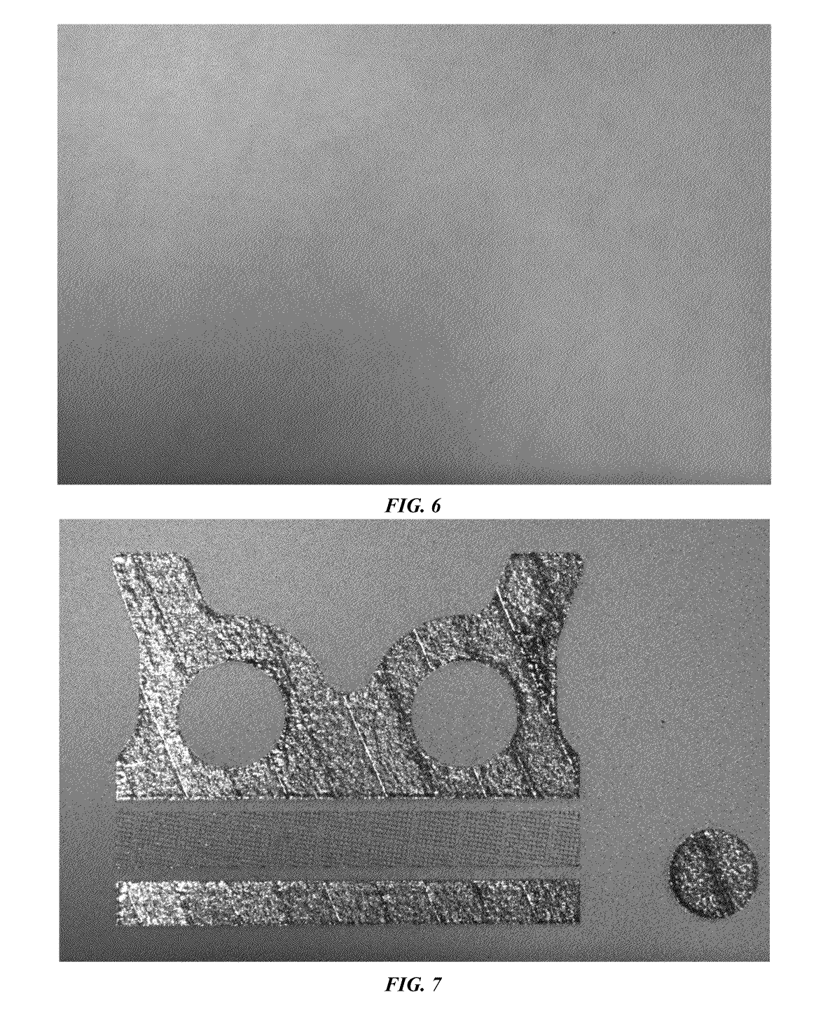

FIG. 6 shows an exemplary flat field image from an actual powder bed during the build of an actual component using an additive manufacturing process, in which the heat source is a scanning laser. The first step in the geometric feature extraction process as outlined in FIG. 5 is that the raw image data is divided by the flat field data on a pixel by pixel basis. This can be symbolically represented by:

(ff_corrected data)ᵢ=(layer_data)ᵢ/(ff_data)ᵢ (2)

where (ff_corrected_data)ᵢ is the pixel value of the i-th pixel after the flat field correction, (layer_data)ᵢ is the pixel value of the i-th pixel of the raw image, and (ff_data)ᵢ is the value of the corresponding i-th pixel from the flat field image.

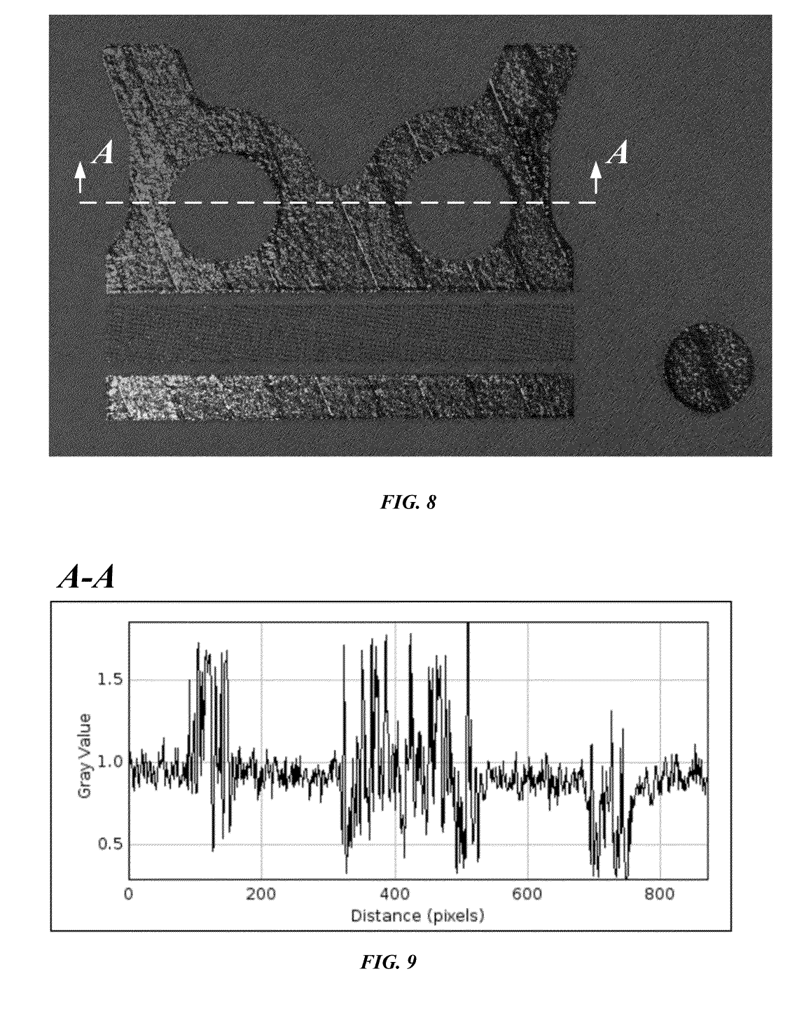

In FIG. 7, we see a raw image from an actual layer taken at an intermediate state of an additive manufacturing process involving sintering a layer of metallic powders using a scanning laser. This is the starting point image and therefore the starting data for the geometric feature extraction process. After the flat field correction is applied, the resulting image is shown in FIG. 8. Another way in which to visualize the specific steps outlined in the geometric feature extraction process as described in FIG. 5 is to examine specific variable data. This is most easily accomplished when a specific set of pixel values along a specific line that cuts through the image is plotted, i.e. a plot of the pixel value as a function of pixel number or location along the line segment. So for example, one such line scan taken from the image shown in FIG. 8 is shown in FIG. 9. So to reiterate, FIG. 8 is the result of applying the algorithm symbolically shown in Equation 2 to FIG. 7, and FIG. 9 is a plot of specific pixel values of FIG. 8 section line A-A of FIG. 8.

The next step in the Geometric Feature Extraction Process as outlined in FIG. 5 is the elimination of the offset from the flat field corrected data. This can be symbolically represented by:

(shifted_data)ᵢ=(ff_corrected_data)ᵢ−(offset)_{I} (3)

where (shifted data)ᵢ is the value of the i-th pixel of the flat field corrected data that has been shifted such that the offset is zero, (ff_corrected_data)ᵢ is the value of the i-th pixel of the flat field corrected data, and (offset)ᵢ is the value of the offset associated with the ith pixel.

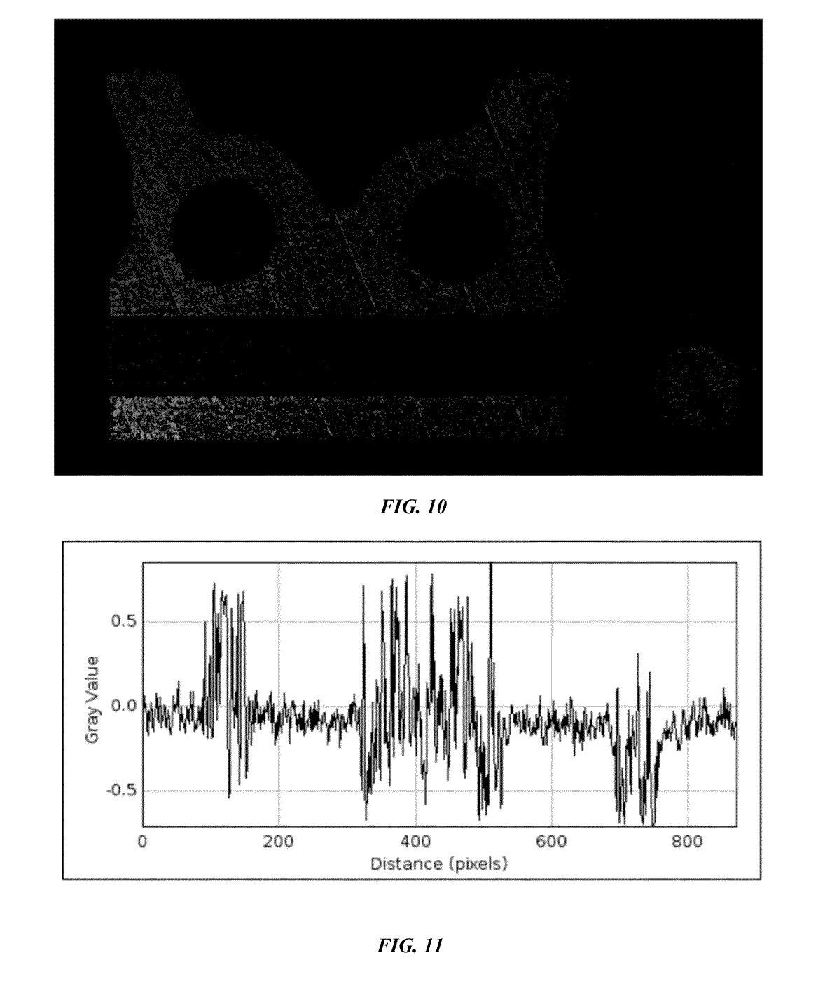

The result of this operation outlined in Equation 3 can be visualized in two ways. First, the corresponding image can be visualized and is shown FIG. 10. So FIG. 10 is the result of taking FIG. 8 and eliminating all the offsets so that the offset is zero. Please note that any pixel value mathematically less than zero due to the shifting operation cannot actually be negative, since the lowest physically real pixel grayscale value possible is 0, which is black. Therefore FIG. 10 is significantly darker than FIG. 8. Alternatively, it is possible to visualize the same operation by looking at the plot of pixel values shown in FIG. 9. FIG. 11 shows the same data as shown in FIG. 9. except that all the non zero offsets have now been eliminated shifting the curve down so it is centered around a gray value of 0.0. Note that mathematically and as depicted, this forces some pixels to assume negative values.

The next step in the Geometric Feature Extraction Process as outlined in FIG. 5 involves the transformation of negative values from the shifted data. As described above, it is mathematically possible for a pixel to assume a negative value, but this is not physically possible as zero is the lowest pixel value physically attainable, i.e. black. Therefore the absolute value of the pixel values is taken, and this is symbolically represented by:

(absval_data)ᵢ=|(shifted data)ᵢ| (4)

where (absval_data)ᵢ is the value of the i-th pixel after the absolute value of the value of the corresponding shifted pixel has been taken, and (shifted_data)ᵢ is the value of the i-th pixel that has been shifted so as to have zero offset.

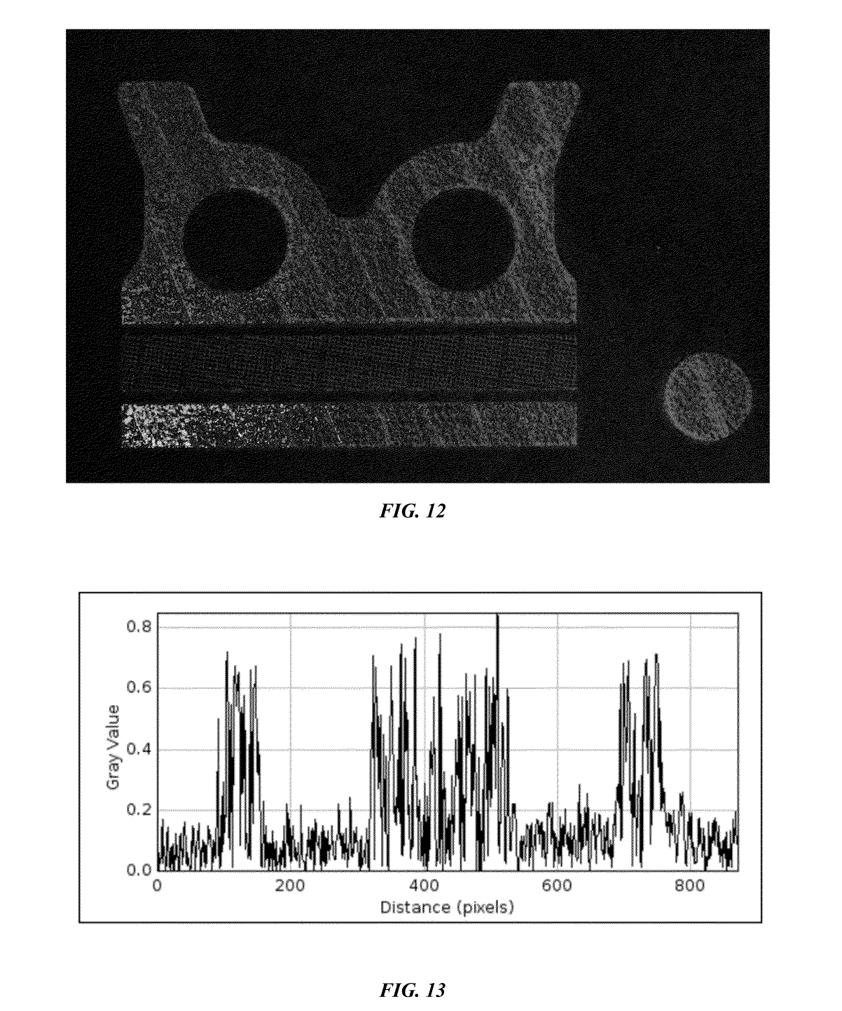

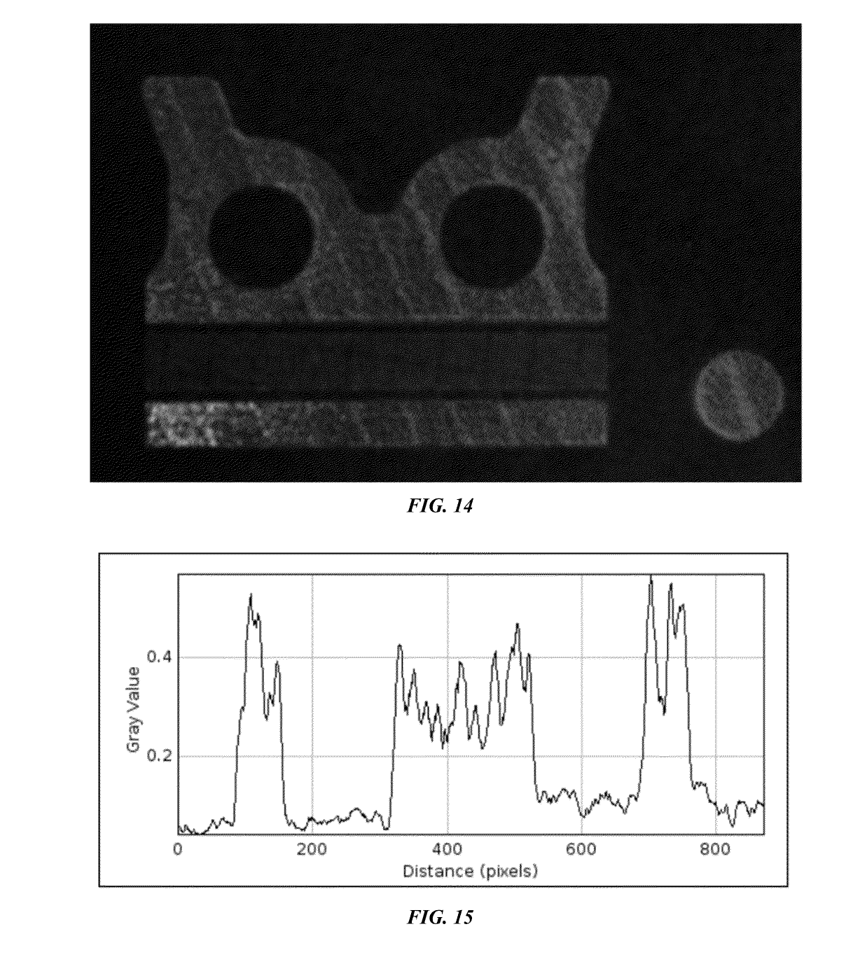

The result of this operation as symbolically shown in Equation 4 can be visualized in two ways. First, the image can be viewed, and this is shown in FIG. 12. Note that FIG. 12 is significantly lighter in contrast as compared to FIG. 10. This is because in FIG. 10, the shifting operation caused many pixels to have mathematical values less than zero, but physically this can only be represented by a minimum pixel value of 0, or black. Now in FIG. 12, the pixels that previously had negative values now have the additive inverse of those negative values, and therefore are non-negative (which could be positive or zero). Therefore FIG. 12 is significantly lighter in contrast than FIG. 10. Alternatively, this can be visualized by looking at the plot of pixel values along a certain line segment as shown before in FIG. 11, but with the absolute value operation applied to each pixel. This is shown in FIG. 13. So to reiterate, FIG. 13 contains the same data as FIG. 11, but with the absolute value operation applied to the value of each pixel in FIG. 11 to get the corresponding pixel in FIG. 13.

The next step in the Geometric Feature Extraction Process as outlined in FIG. 5 is a smoothing operation. This can be accomplished is a myriad of ways and there are many different smoothing algorithms available that operate in one or more dimensions. This also falls under the very broad category of image noise reduction. There are many different kinds of noise that manifest in a digital image, and there are also many techniques for the reduction of such image noise. In the specific instance shown in this example, a near neighbor noise reduction technique is employed. This involves localized averaging of pixel values. For example, the circle could be defined around a specific pixel, and the value of the pixel could be replaced by some sort of weighted average of the surrounding pixels within that certain circle of a given radius. One class of such near neighbor noise reduction techniques is called Gaussian Blur, which uses a Gaussian weighting function to enable the smoothing. In general, the smoothing operation can be symbolically represented by:

$$( smoothed\_data ) = \frac{{\sum }_{j = 1}^{N} {w}_{j} \cdot {( absval\_data )}_{j}}{{\sum }_{j = 1}^{N} {( absval\_data )}_{j}} \qquad ( 5 )$$

where: (smoothed_data)ᵢ is the smoothed value of the ith pixel, N is the number of pixels within a radius R of the −ith pixel, (absval_data)ⱼ is the value of the j-th out of N pixels within a radius R of the ith pixel, and wⱼ is the value of the weighting function for the jth out of N pixels that lie within a radius R.

The result of this operation can be visualized in two ways. First, the image of the layer subjected to this operation can be visualized. This is shown in FIG. 14. FIG. 14 is derived from FIG. 12, but with the smoothing application applied on a pixel by pixel basis. Alternatively, it is possible to visualize the smoothing process by looking at a plot of pixel values along a given line segment that intersects the image. This is shown in FIG. 15. FIG. 15 is the data shown in FIG. 13, but with the smoothing algorithm applied on a pixel by pixel basis.

The next step in the Geometric Feature Extraction Process as described in FIG. 5 is a normalization step. In this step, the value at each pixel is divided by the maximum pixel value in the image. Therefore the resultant pixel value data will occupy the interval [0,1]. This can be symbolically represented by:

(normalized_data)ᵢ=(smoothed_data)/MAXVAL (6)

where: (normalized_data)ᵢ is the values of the i-th normalized pixel, (smoothed_data)ᵢ is the value of the i-th smoothed but nonnormalized pixel, and MAXVAL is the maximum pixel value for any pixel in the smoothed data set derived in Equation 5.

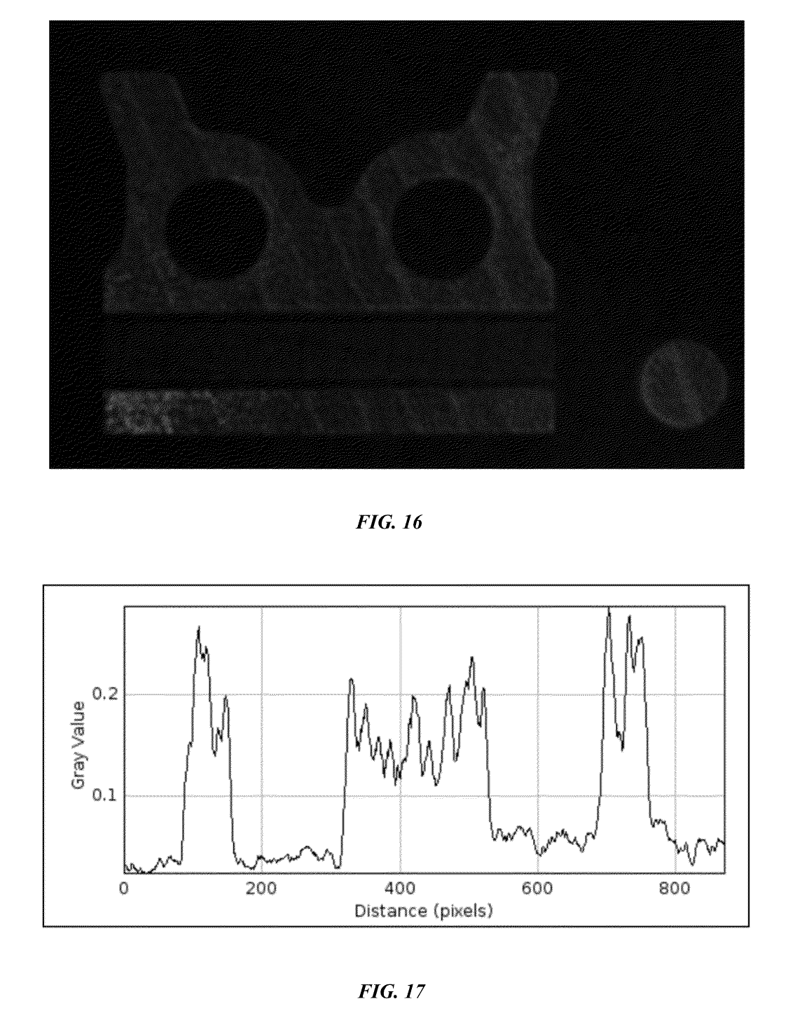

The result of this operation can be visualized in two ways. First the image of the layer subjected to this operation can be visualized. This is shown in FIG. 16. FIG. 16 is essentially FIG. 14 but with the pixel values now normalized to the interval [0,1]. Not surprisingly, FIG. 16 is a lot darker in contract as compared to FIG. 14, because the overall value of the pixel intensities has been reduced through the normalization process. Alternatively, it is possible to visualize the normalization process by looking at a plot of the pixel values along a given line segment that intersects the image. This is shown in FIG. 17. FIG. 17 is essentially the data in FIG. 15, but with the value of each pixel normalized by the maximum value of any pixel in the image. Therefore the vertical scale in FIG. 17 is numerically lower than the vertical scale in FIG. 15.

The next step in the Geometric Feature Extraction Process as outlined in FIG. 5 is the conversion of all data into purely back and white data. In this step, each pixel is converted into either a back pixel or a white pixel, i.e all other intermediate values between the end points of the range are converted into one end point or the other. In practice, this is done by first establishing a threshold value. Any pixel with a value that is greater than the threshold value is assigned a value at the upper extreme of the range, i.e. white, and any value below the threshold is assigned a value at the bottom of the range, i.e. black. This may be symbolically represented as follows:

a. (monochromatic_data)ᵢ=1 for all values of (normalized_data)ᵢ>THRESHOLD

b. (monochromatic_data)ᵢ=0 for all values of (normalized_data)ᵢ≦THRESHOLD (7)

Where: (monochromatic_data)ᵢ is the value of the i-th pixel after conversion to a black and white pixel value, i.e. 0 or 1, (normalized_data)_{I} is the value of the i-th pixel of the normalized data, and THRESHOLD is the threshold value that is used to determine if a given pixel under this operation will assume the value 1 or 0.

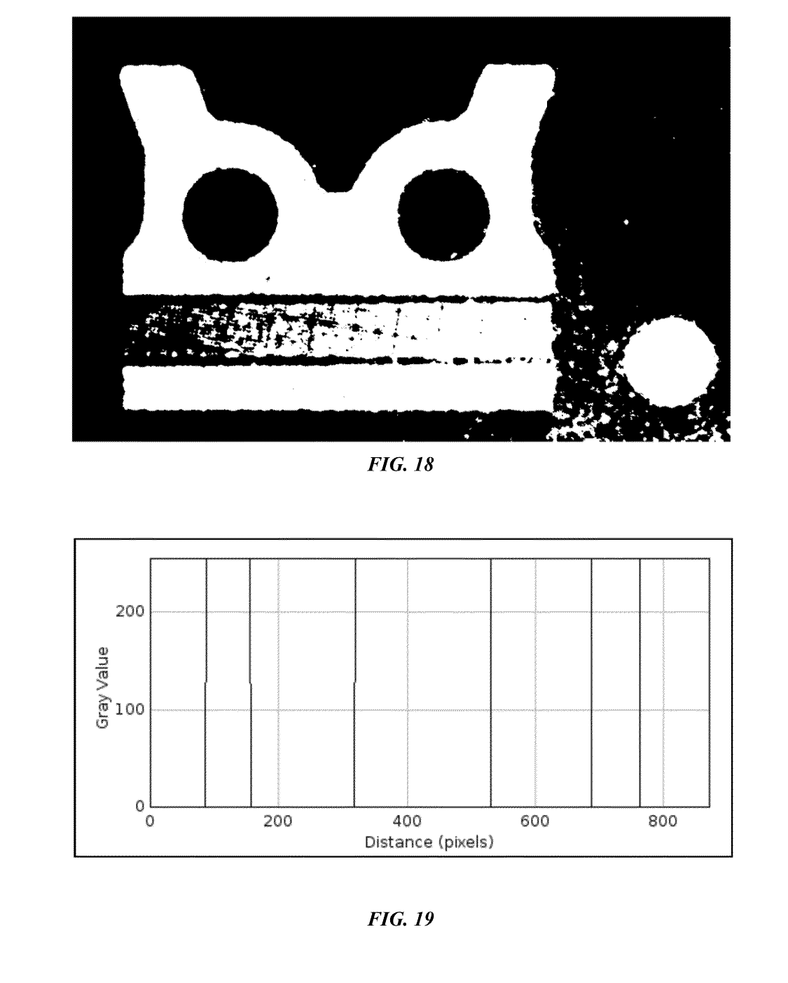

The effects of this operation may be visualized in two ways. First, it is possible to view the image of the layer that has been subjected to this operation. This is shown in FIG. 18, which is the result of taking FIG. 16 and turning all the pixels either white or black based on a threshold value as shown in Equation 7. Alternatively, it is possible to visualize the black and white thresholding process by looking at a plot of the pixel values along a given line segment that intersects the image. This is shown in FIG. 19, which is derived by taking the data in FIG. 17 and reassigning values of either 0 or 1 to each pixel based on whether it is above or below the threshold value. Closely associated with the black and white thresholding process is the gap filling process. This process is not really distinct from the black and white thresholding process, but rather an associated step that seeks to fill geometric irregularities in the white/black boundary. Various techniques for such filling are available. One class of such techniques among many others is known as dilation. This filling step will be considered as closely associated with the binary black and white threshold step.

The next step in the Geometric Feature Extraction Process as described in FIG. 5 is the edge detection process. This operation is applied to the black and white image, and seeks to identify the set of elements which occupy the boundary between the largely white regions and the largely black regions. As there are many possible algorithmic methods for edge detection, the symbolic representation is very generic and may be represented by:

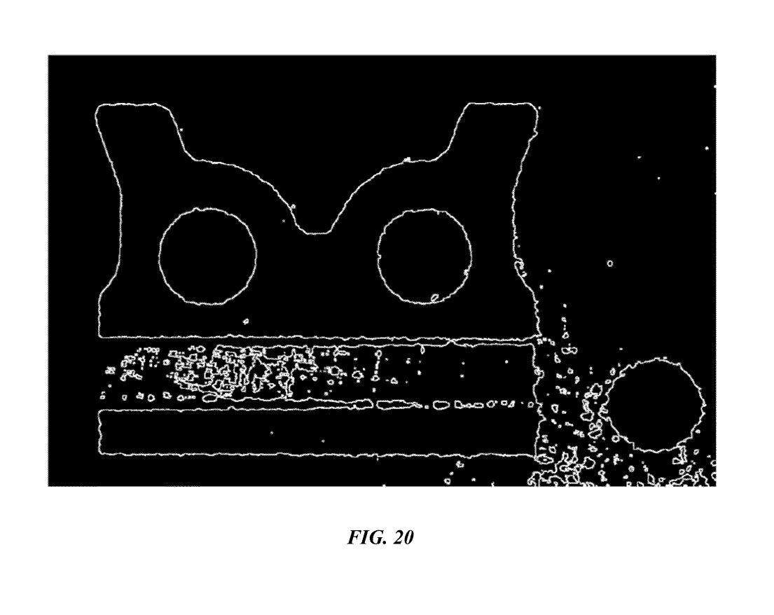

{BOUNDARY}={φ(monochromatic_data)ᵢ} (8)

where: {BOUNDARY} is the set of pixels which define the boundaries, [112] j is the edge detection operator or algorithm, and (monochromatic_data)ᵢ is the set of all pixels which have been converted to purely a purely binary black and white image. In FIG. 20, the result of applying a given edge detection algorithm to the binary black and white image in FIG. 18 is shown.

The final step of the Geometric Feature Extraction Process as shown in FIG. 5 is the scaling process by which physically realistic dimensions are assigned to the edges detected by virtue of Equation 8 and as shown in FIG. 20. Essentially this step consists of applying the scale factors of Equation 1 to the image shown in FIG. 20. The practical result of performing such a scaling is that the image can now be directly compared to a model or ideal representation of what the part should look like, i.e. the desired geometric state as specified in the Design Intent 101. The end result and practical import of this present invention is the ability to compare, on a layer by layer basis, the actual as-built geometry to the desired Design Intent at that same location and layer.

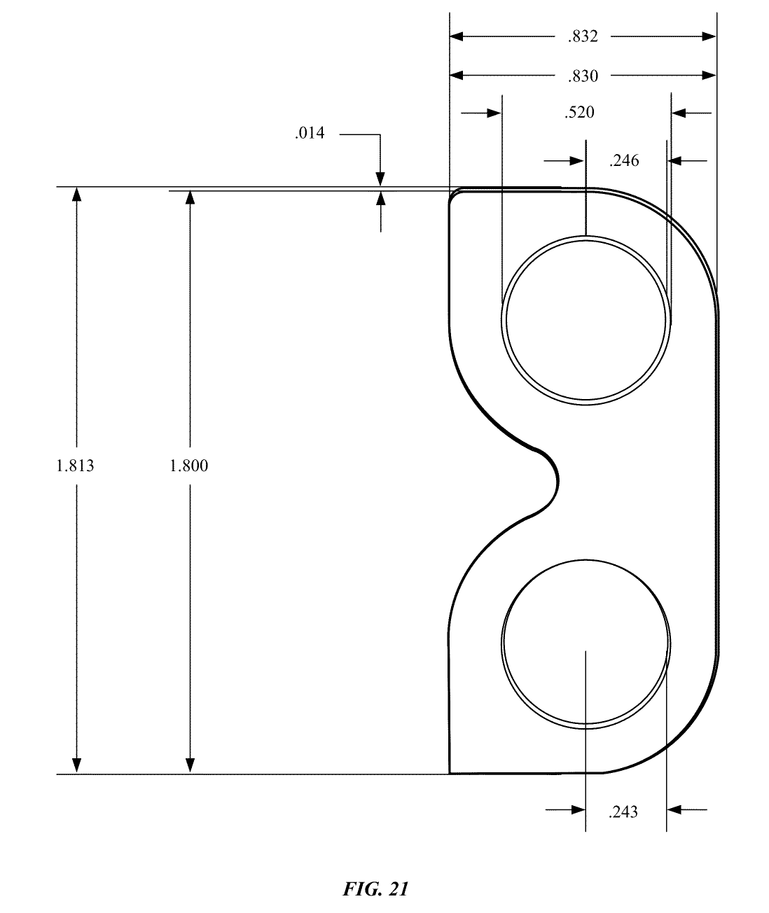

FIG. 21 shows the end result of such a comparison. All dimensions are in inches. It is seen in FIG. 21 that the largest deviation between the as-built shape and the desired Design Intent shape is 0.014 inches, which is equivalent to 356 micrometers. This is roughly three times the size of the weld pool in this specific instance and is reasonably large. So, to reiterate, FIG. 21 is the logical culmination of this present invention. It marks the end of the process from transforming raw sensor data to extracting geometric features to providing exact data indicating the extent of compliance to the Design Intent 101 insofar as the geometrical properties of the manufactured article are concerned.

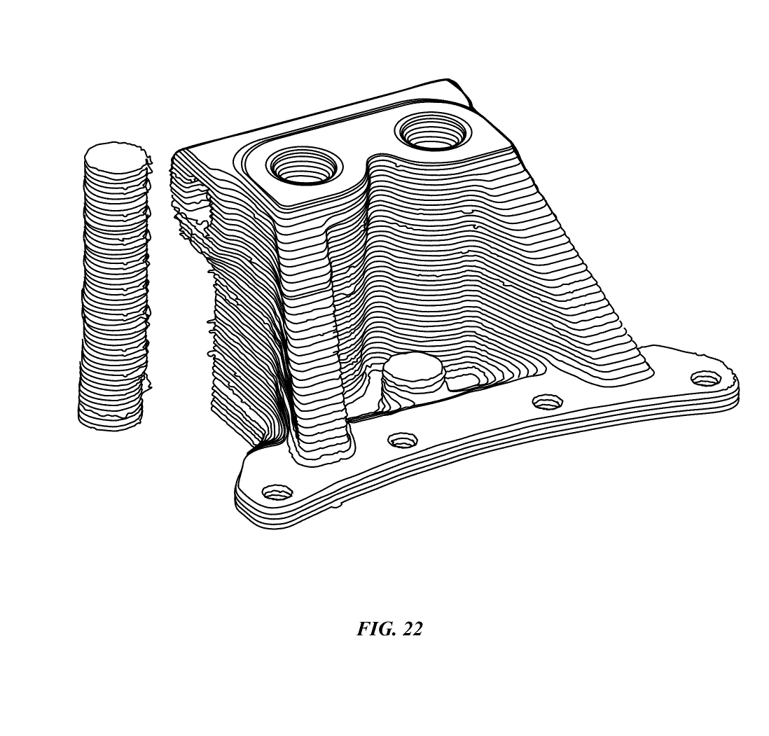

As one further extension of the techniques and methods taught in this present invention, consider the concatenation of a whole series of Figures such as that shown in FIG. 21, but now at a large number of intermediate states of the additive manufacturing process as it created the article to be manufactured. So at each such intermediate state, or layer, the geometrical properties of the as-built article can be compared to the geometrical properties of the desired Design Intent. This is also equivalent to superimposing or juxtaposing the individual 2D contours onto a 3D solid model of the part, i.e. the geometric manifestation of Design Intent 101. FIG. 22 shows how data obtained by applying image processing to the images taken while building each layer of the part can be aggregated together to determine a geometry of the part. This data can be subsequently compared to designs for the part along the lines of three dimensional CAD models. A comparison between the aggregated layers and the design can show variations of any internal or external geometric features of the part. FIG. 22 is basically an extension of the concepts shown in FIG. 21, but for a truly 3D object and solid model.

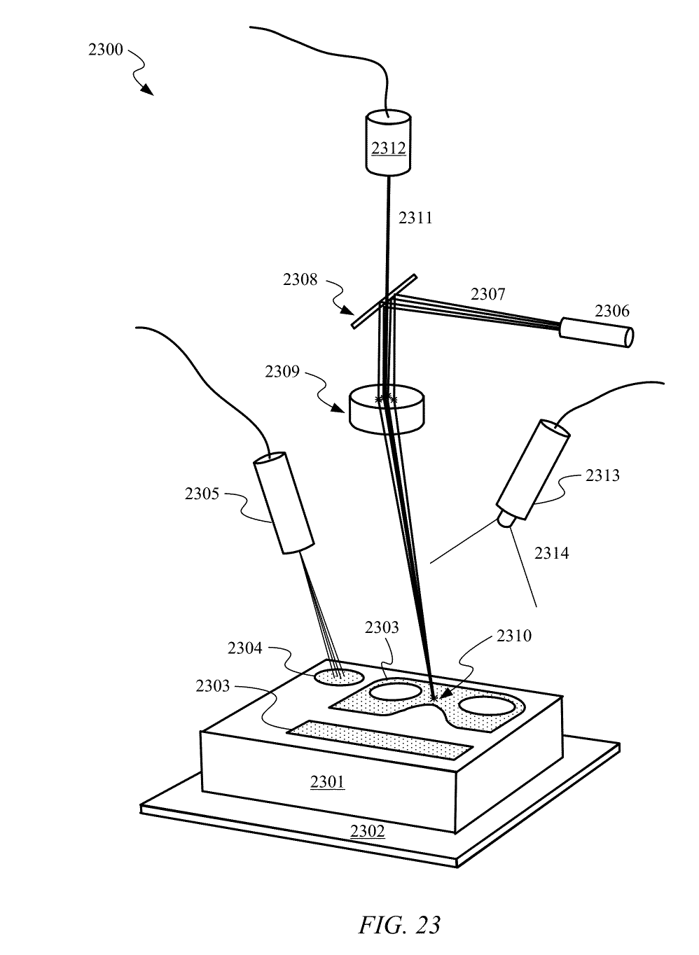

FIG. 23 shows a perspective view illustrating a quality control system 2300 suitable for use with the previously described embodiments. The quality control system 2300 can be utilized in conjunction with additive manufacturing processes in which a moving heat, used to sinter portions of each layer of powder, takes the form of a laser. The material addition could be either through the sequential pre-placement of layers of metal powders to form a volume of powder 2301, as depicted and previously discussed, on a powder bed 2302; alternatively, the material addition could be accomplished by selectively placing powder straight into the molten region generated by the moving laser on the part. The volume of powder 2301 has several distinct build regions 2303, which are being built up. In the case of the depicted embodiment, the buildup is accomplished by the application of the heat source to the material build regions 2303, which causes the deposited powder in those regions to melt and subsequently solidify into a part having a desired geometry. The various regions 2303 could be different portions of the same part, or they could represent entirely different parts.

As illustrated in FIG. 23, a witness coupon 2304 is provided. Witness coupon 2304 is a standardized volume element that will be called a witness coupon, which allows the sampling of every production build and which represents a small and manageable but still representative amount of material which could be destructively tested for metallurgical integrity, physical properties, and mechanical properties. For every layer that is put down, the witness coupon 2304 also has a layer of material put down concurrent to the layer being processed in the distinct build regions 2303. There is an optical sensor 2305, for example a pyrometer, directly interrogating the witness coupon 2304. For purposes of clarity, optical sensor 2305 is represented as a pyrometer herein although it will be evident to one of skill in the art that other optical sensors could be utilized. The pyrometer 2305 is fixed with respect to the powder bed 2302 and collects radiation from a fixed portion of the volume of powder 2301, i.e., the witness coupon 2304.

In the instance where the additive manufacturing process includes a scanning laser impinging on powder bed 2302, the laser source 2306 emits a laser beam 2307 that is deflected by a partially reflective mirror 2308. Partially reflective mirror 2308 can be configured to reflect only those wavelengths of light that are associated with wavelengths of laser beam 2307, while allowing other wavelengths of light to pass through partially reflective mirror 2308. After being deflected by mirror 2308, laser beam 2307 enters scan head 2309. Scan head 2309 can include internal x-deflection, y-deflection, and focusing optics. The deflected and focused laser beam 2307 exits the scan head 2309 and forms a small, hot, travelling melt pool 2310 in the distinct build regions 2303 being melted or sintered layer by layer. Scan head 2309 can be configured to maneuver laser beam 2307 across a surface of the volume of powder 2301 at high speeds. It should be noted that in some embodiments, laser beam 2307 can be activated and deactivated at specific intervals to avoid heating portions of the volume of powder 2301 across which scan head 2309 would otherwise scan laser beam 2307.

Melt pool 2310 emits optical radiation 2311 that travels back through scan head 2309 and passes through partially reflective mirror 2308 to be collected by optical sensor 2312. The optical sensor 2312 collects optical radiation from the travelling melt pool 2310 and therefore, images different portions of the volume of powder 2301 as the melt pool 2310 traverses the volume of powder 2301. A sampling rate of optical sensor 2312 will generally dictate how many data points can be recorded as melt pool 2310 scans across the volume of powder 2301. The optical sensor 2312 can take many forms including that of a photodiode, an infrared camera, a CCD array, a spectrometer, or any other optically sensitive measurement system. In addition to pyrometer 2305 and optical sensor 2312, quality control system 2300 can also include optical sensor 2313 along the lines of the optical sensor utilized in conjunction with the feature extraction process described above. Optical sensor 2313 can be configured to receive optical information across a wide field of view 2314 so that real time monitoring of substantially all of the volume of powder 2301 can be realized. Optical sensor 2313 can be capable of continuously monitoring all of the volume of powder 2301 or only periodically as described above after each layer of powder undergoes a sintering operation.

When melt pool 2310 passes through the region of witness coupon 2304, both the Eulerian pyrometer 2305 (i.e., the pyrometer 405 interrogates a fixed portion of the region of the metal material that is being additively constructed, thereby providing measurements in a stationary frame of reference) and the Lagrangian optical sensor 412 (i.e., the optical sensor 412 images the location at which the laser energy is incident, thereby providing measurements in a moving frame of reference) are looking at the same region in space. At the witness coupon, signals from the Eulerian pyrometer 405, Lagrangian optical sensor 2312, and the Eulerian optical sensor 2313 will be present, a condition that can be associated with the witness coupon. Calibration of the readings from the sensors can thus be performed when the melt pool overlaps the witness coupon. By comparing the readings from the sensors to a set of baseline sensor data developed by conducting multiple trials during which large geometric and heat variations are observed, conditions during the manufacturing process corresponding with undesirable part outcomes can be quickly identified. In some embodiments, a build process can be halted when an out of parameter operation is detected by the sensor. In this way, the part can be discarded or further analysis can be conducted prior to continuing with the build process. In this way, errors or variations in the manufacturing process that are likely to produce defects that result in substandard or unusable parts can be identified early. In some embodiments, more minor variations can simply be identified and flagged as constituting a potentially substantial defect.

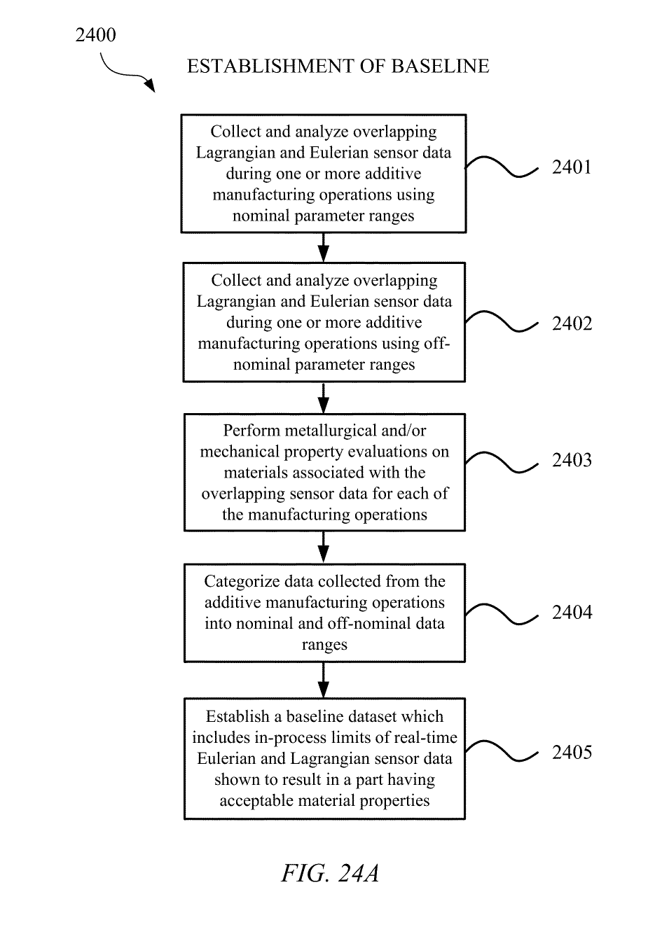

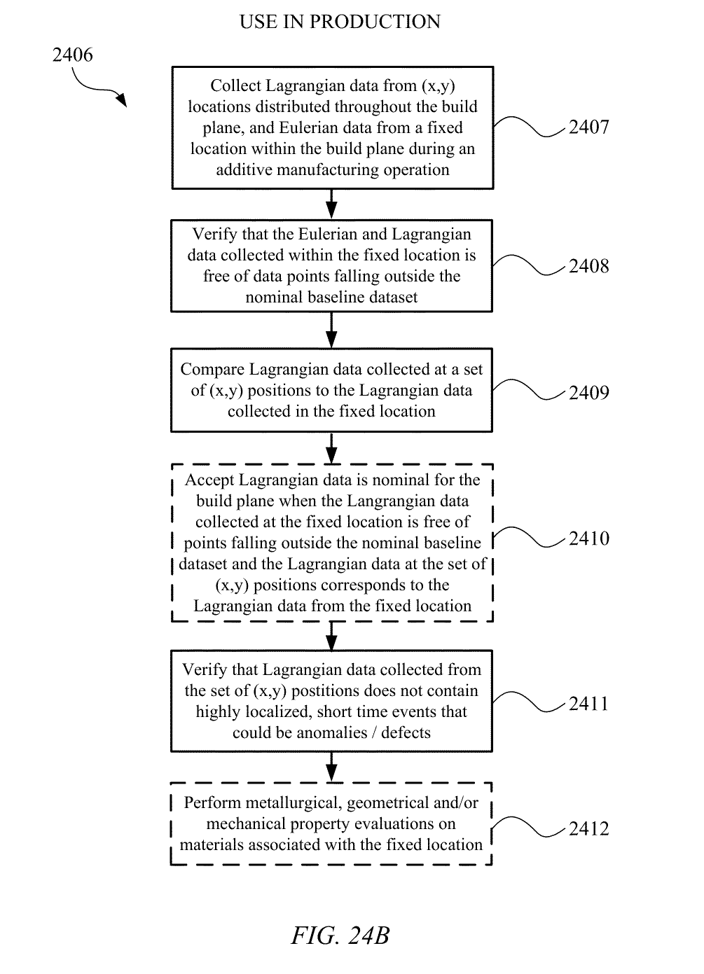

FIG. 24A is a flowchart illustrating a process 2400 for establishing a baseline parameter set for building a part according to an embodiment of the present invention. For example, the process depicted in FIG. 24A can be used to develop a baseline parameter set for use in a setup similar to the one shown in FIG. 23. Referring to FIG. 24A, the method includes, at block 801, collecting and analyzing overlapping Eulerian and Lagrangian sensor data during one or more additive manufacturing operations using nominal parameter ranges (e.g. those parameter ranges known to produce parts having acceptable characteristics). In some embodiments, the overlapping portion of the sensor data coincides with material that is separate and distinct from a part being constructed (sometimes this portion can be referred to as a witness coupon), while in other embodiments, the overlapping sensor data coincides with a portion of the part itself. In cases where the overlapping sensor data is located within the part itself, that portion of the part may need to be removed if verification of the micro-structural integrity of that portion is desired without destroying the part. The Eulerian and Lagrangian sensor data can be collected from multiple sensors such as pyrometers, infrared cameras, photodiodes and the like. The sensors can be arranged in numerous different configurations; however, in one particular embodiment a pyrometer can be configured as a Eulerian sensor focused on a fixed portion of the part, and a photodiode or other optical sensors, can be configured as a Lagrangian sensor, which follows the path of a heating element that scans across the part. In addition to collecting temperature data, geometric data can also be collected with an optical sensor and associated with each set of data produced while establishing the baseline.

Data collection begins by testing nominal parameter ranges (i.e., those parameters or control inputs which are likely to result or have resulted in acceptable microstructure and/or acceptable mechanical properties and/or acceptable defect structures for a particular metal being utilized). In some embodiments, a user may begin with more or less precise parameter ranges when establishing the nominal parameter ranges. It should be understood that beginning with a more precise nominal parameter range can reduce the number of iterations needed to yield a sufficient number of data points falling within the nominal parameter ranges for a particular part. When a witness coupon is being utilized, it should be appreciated that the Lagrangian data can be transformed using the transfer function as indicated in Equation 9 for the region of the witness coupon.

Once a sufficient number of data points corresponding to the part having acceptable material properties have been collected, additional additive manufacturing operations are conducted using off-nominal parameter ranges. During these manufacturing operations, overlapping Eulerian and Lagrangian sensor data are collected and analyzed (802). Similar to the data collection method used with the nominal data collection, the sensors can focus on the same portion of the part utilized for the collection of nominal data. The Lagrangian data will again be transformed with the aid of Equation 9. Off-nominal parameter ranges are those parameter ranges (e.g., laser power, scan speed, etc.) that have been verified to result in unacceptable microstructure and/or mechanical properties and/or defect structures as determined by post-process destructive analysis of the witness coupon or equivalent regions of the build. Off-nominal data collection can include multiple part builds to establish boundaries or thresholds at which a part will be known to be defective. Off-nominal data collection can also include test runs in which laser power is periodically lowered or raised using otherwise nominal parameters to help characterize what effect temporary off parameter glitches can have on a production part. As described more fully below, collection and analysis of the in-process sensor data during a set of manufacturing processes using the off-nominal parameter conditions can be used to define the in-process limits for the in-process sensor data. Embodiments of the present invention, therefore, measure attributes of the process (i.e., in-process sensor data) in addition to measuring attributes of the part manufactured. An optical sensor can also be used in the off-nominal parameter runs to characterize what part geometries correspond with the off-nominal parameter ranges.

At 2403, one or more portions of the part at which the Eulerian and Lagrangian sensor data overlaps (i.e. the witness coupon) are analyzed to help produce a baseline dataset. There are generally four kinds of analysis that could be performed on the witness coupon, or an equivalent region of the part. First, the microstructure could be examined in detail. This includes, but is not limited to, such analyses as grain size, grain boundary orientation, chemical composition at a macro and micro scale, precipitate size and distribution in the case of age hardenable alloys, and grain sizes of prior phases which may have formed first, provided that such evidence of these previous grains is evident. The second category of evaluations that could be conducted are mechanical properties testing. This includes, but is not limited to, such analyses as hardness/micro-hardness, tensile properties, elongation/ductility, fatigue performance, impact strength, fracture toughness and measurements of crack growth, thermos-mechanical fatigue, and creep. The third series of evaluations that could be conducted on witness coupons or equivalent regions of the build are the characterization of defects and anomalies. This includes, but is not limited to, analysis of porosity shape, size and distribution, analysis of crack size and distribution, evidence of inclusions from the primary melt, i.e., those form during the gas atomization of the powders themselves, other inclusions which may have inadvertently entered during the additive manufacturing process, and other common welding defects such as lack of fusion. The fourth series of evaluations could be conducted by measuring geometric variations in the witness coupon caused by off-nominal parameter use. In this way, geometric features consistent with off-nominal parameter use can also be correlated with defective parts and used to identify defects in a part. Actual measurement of the resulting part can also help to determine how close the geometric feature extraction is getting to actual geometric feature production in off-nominal conditions. This geometric measurement of the part could be utilized to determine when a higher than desired amount of heat applied near the surface of the part results in surface variations extractable and accurately measurable by the geometric feature extraction described above. It should also be noted that in certain cases a location of the witness coupon or focus of the pyrometer can be adjusted to provide a more accurate representation of particularly critical portions of the part.

At step 2404, once both in-process sensor data (Eulerian and transformed Lagrangian data) as well as post-process data (microstructural, mechanical, geometrical and defect characterizations) have been collected, it is possible to use a wide variety of outlier detection schemes 804 and/or classification scheme that can bin the data into nominal and off-nominal conditions. Also, the process conditions resulting in a specific set of post-process data are characterized, the associated in-process data collected while the sample was being made. This in-process data, both Eulerian and Lagrangian, can be associated and correlated to the post-process sample characterization data. Therefore, a linkage can be made between distinct post-process conditions and the process signatures in the form of in-process data that produced those post-process conditions. More specifically, feature extracted from the in-process data can be directly linked and correlated to features extracted from the post-process inspection. In some embodiments, the data collected during manufacturing using the nominal parameter range will be distinct from the data collected during manufacturing using the off-nominal parameter ranges, for example, two distinct cluster diagrams. One of ordinary skill in the art would recognize many variations, modifications, and alternatives.

At step 2405, once such features are established and correlated both in the real-time and post-process regimes, a process window can be defined based on the in-process limits of both Eulerian and Lagrangian data corresponding to nominal conditions, i.e., those conditions that have been verified to result in acceptable microstructure and/or acceptable mechanical properties and/or acceptable defect structures as determined by post-process destructive analysis of the witness coupon or equivalent regions in the build. Therefore the practical import of achieving this state is that the process may be defined to be in a nominal regime by virtue of actual in-process measurements directly corresponding to the physical behaviors occurring in the additive manufacturing process, as opposed to defining such a process window by using ranges of the machine settings, or other such variables included in a process parameter set, which are further removed from the process. In other words, embodiments of the present invention differ from conventional systems that only define process parameters. Embodiments of the present invention determine the in-process data for both nominal parameter ranges (2401) and off-nominal ranges (2402), providing an “in-process fingerprint” for a known set of conditions. Given that established baseline dataset, it is possible, for each material of interest and each set of processing conditions, to accurately predict the manufacturing outcome for a known-good product with desired metallurgical and/or mechanical properties.

It should be appreciated that the specific steps illustrated in FIG. 24A provide a particular method of establishing a baseline parameter set for building a part according to an embodiment of the present invention. Other sequences of steps may also be performed according to alternative embodiments. For example, alternative embodiments of the present invention may perform the steps outlined above in a different order. Moreover, the individual steps illustrated in FIG. 24A may include multiple sub-steps that may be performed in various sequences as appropriate to the individual step. Furthermore, additional steps may be added or removed depending on the particular applications. One of ordinary skill in the art would recognize many variations, modifications, and alternatives. Now the attention is shifted to the practical use of such a process window in a production environment.

FIG. 24B is a flowchart illustrating a process 2406 for classifying a quality of a production level part based upon the established baseline parameter set according to an embodiment of the present invention. FIG. 24B shows process 2406 describing the use of the baseline dataset in a build scenario. The baseline dataset can be established using the method illustrated in FIG. 24A.

Block 2407 represents the collection, during an additive manufacturing process, of Lagrangian data from (x,y) locations distributed throughout the build plane and Eulerian data from fixed locations within the build plane. In one particular embodiment, the Lagrangian data can be collected by a photodiode and the Eulerian data can be collected by a pyrometer configured to take continuous imagery of a small portion of the build plane and another optical sensor configured to take periodic or continuous images of the entire build plane for conducting geometric feature extraction. The fixed location targeted by the pyrometer can be a witness coupon or a portion of the part that will be subsequently removed for testing. In some embodiments, the Lagrangian data can be collected from all locations in the build plane and the Eulerian data collected by the pyrometer can be collected only at the fixed region of the witness coupon, although the present invention is not limited to this implementation. In other embodiments, a subset of all possible locations is utilized for collection of the Lagrangian data. The Lagrangian data is collected in the fixed region of the witness coupon as the melt pool passes through the witness coupon region. One of ordinary skill in the art would recognize many variations, modifications, and alternatives.

Block 2408 describes a verification process that can be executed to determine whether the Eulerian and Lagrangian data collected within the witness coupon is free of data points falling outside the nominal baseline dataset (i.e., within the region defined by the baseline dataset). The same classification and outlier detection scheme as was implemented during the establishment of the baseline in process 800 can be used to perform this verification. In other words, this step establishes that overlapping Eulerian and Lagrangian sensor readings taken during an actual production run corresponds to overlapping Eulerian and Lagrangian sensor readings recorded under nominal conditions as part of the baseline data set.

Block 2409 describes the comparison of Lagrangian data collected at one or more (x,y) positions to the Lagrangian data collected in the fixed location. In some embodiments, the Lagrangian data collected at each of the (x,y) positions is compared to the Lagrangian data collected from the fixed region associated with the witness coupon. Thus, a set of in-process Lagrangian data associated with portions or all of the build platform can be compared with a set of in-process data from the witness coupon region. This step can be carried out subsequent to block 808 when it is established that the Lagrangian data from the fixed location in the production run was within the range of nominal conditions described in the baseline dataset. Accordingly, the embodiment illustrated in FIG. 24B compares the Lagrangian data set associated with some or all of the build platform areas with the Lagrangian data set from the witness coupon, as well as verifies that the in-process data is within the limits of the baseline dataset. Geometric feature extraction derived from data collected by the optical sensor monitoring the entire build plane can also be utilized to identify that the geometry being produced outside the witness coupon corresponds to nominal processing parameters.

In optional block 2410 when the verification and comparison from blocks 2408 and 2409 are completed successfully at all desired sampling points in the part, then the entire part is by logical inference, also within the limits of the nominal baseline data set.

Block 2411 can provide a useful verification of a parts quality/conformance to the baseline dataset. Block 2411 describes an additional verification that is carried out to verify that no anomalies exist in the Lagrangian signal of the build that did not exist in the baseline. As an example, short temporal anomalies and/or highly localized may physically represent some irregularity in the powder sintering, presence of a foreign object in the powder bed, a fluctuation in the laser power, melting at a highly localized level, or the like. An indication of an anomaly can then be provided to a system operator as appropriate. In response to the indication, a quality engineer may require that the part undergo additional testing to determine if the temporal anomaly will impact part performance. The verification process in 2411 can differ from that performed in 808 since the time scale associated with the verification processes can be significantly different. Additionally, differing thresholds can be utilized to provide the appropriate filtering function. For example, the verification process can be applied to every data point collected that exceeds a fairly substantial threshold value while the process in 2408 might only consider a smaller number of data points (i.e. at a reduced sampling rate) with a much lower threshold for irregular measurements. In some embodiments, block 2411 can be optionally performed and is not required by the present invention. In some embodiments, the order of the verification processes in 808 and 811 is modified as appropriate to the particular application. In some embodiments, the verification process in 2411 can be conducted using data from a different sensor than that used in block 808, for example the sensor associated with the verification can be a high speed camera sampling temperature data thousands of times per second. This high speed sensor could have a lower accuracy than a sensor associated with block 808 as it would be designed to catch very substantial but transitory deviations from the baseline dataset.

Lastly, block 2412 describes an optional process. This optional process can be carried out when an overall confidence with the production part process is still in doubt. In such a case, material corresponding to the fixed location can be destructively tested to ensure that the post-process metallurgical, mechanical, geometrical or defect-related features of the build witness coupon are within the same limits as those for a nominal baseline witness coupon. In some embodiments, the aforementioned destructive testing can be performed only periodically or in some cases not at all.

It should be noted that as part of the method of producing production parts, computer numerical control (CNC) machinery used to drive the additive machining toolset can also be responsible for executing certain actions based on the aforementioned sensor data. For example, multiple thresholds can be established and correlated with various actions taken by the CNC machinery. For example, a first threshold could trigger recording of an out of parameters event, a second threshold could prompt the system to alert an operator of the tool set, while a third threshold could be configured to cease production of the part.

Conversely, if any of these conditions are not met and if the (x,y) location of the Lagrangian data is known, then that specific region of the build or production run may be categorized as “off-nominal,” or potentially suspect and potentially containing microstructure, mechanical properties, or defect distributions that are unacceptable. In some embodiments, where the Lagrangian data only shows a minor fluctuation making a defect possible but not certain these off-nominal areas can be compared to and further analyzed non-destructively using the geometric features generated in the off-nominal areas by the geometric feature extraction methods discussed above.

In some embodiments, when a defect determination from the captured Lagrangian data may be more difficult to confirm, the geometric feature data derived as discussed above from the data gathered by optical sensor 2313 can be used in conjunction with temperature data gathered by pyrometer 2305 and optical sensor 2312. For example, the geometric feature extraction data can be analyzed to determine whether the temperature variation had any impact on the shape of a particular layer of the part. Furthermore, when a substantial geometric variation is identified by the geometric feature extraction process, temperature data (i.e. Largrangian data) can be analyzed to attempt to determine a reason or even a likely severity of the geometric feature variation. In some embodiments, the Lagrangian data could be used to clear possible error detections made by the geometric feature data.

The geometric feature data and temperature data can also be overlaid on a three dimensional plot similar to the one shown in FIG. 22, in which temperature data and measure geometric feature data are overlaid. In this way, an operator can be presented with a visual representation of any particular problem areas. In some embodiments, an application processor can process computer code configured to identify variations from the temperature and geometric feature data in real time and point out or alert the operator. An operator would then be able to take a closer look at the out of tolerance area so that additional considerations can be made. If for example, the portion of the part that experienced the temperature variation showed no geometric feature variation the build could be continued. In a case where geometric features were varying and deemed to vary by an unacceptable amount from baseline data the build could be stopped; however, in a build where multiple parts were being constructed the operator could request a change in the build causing the heat source to pass over the part or parts coinciding with the variation so that no additional time is wasted producing an out of tolerance part(s).

Therefore FIGS. 24A-24B show embodiments of the present invention as it pertains to the use of in-process Eulerian and Lagrangian data in a production run, the relationship to baseline data and specifically baseline data taken from witness coupons made under nominal conditions known to produce acceptable post-process features, and the methodology by which the in-process Eulerian and Lagrangian data during build run together with the witness coupon associated with the build run may be used to accept a build run as nominal, i.e. representative of the baseline made using process conditions known to produce an acceptable microstructure and/or acceptable mechanical properties and/or acceptable defect distributions.

It should be appreciated that the specific steps illustrated in FIG. 24B provide a particular method of classifying a quality of a production level part based upon the established baseline parameter set according to an embodiment of the present invention. Other sequences of steps may also be performed according to alternative embodiments. For example, alternative embodiments of the present invention may perform the steps outlined above in a different order. Moreover, the individual steps illustrated in FIG. 24B may include multiple sub-steps that may be performed in various sequences as appropriate to the individual step. Furthermore, additional steps may be added or removed depending on the particular applications. One of ordinary skill in the art would recognize many variations, modifications, and alternatives.

The present invention provides a general means and system for utilizing in-process data to provide objective compliance with Design Intent as far as geometrical properties are concerned and without the constant reliance upon postprocess inspection methods and techniques.

The present inventions provides a general means and system for determining the geometrical properties of an article being manufactured by an additive manufacturing process at any number of discrete intermediate states of the process, i.e. layers in the case of a powder bed process.

The present invention provides for a means of concatenating layer data collected from a multiplicity of layers representing various intermediate states of the additive manufacturing process so that a comparison to a fully 3D solid model could be made.

This approach taught in this present invention is therefore fully compatible with a models-based engineering, design, and manufacturing methodology in which a single master solid model is used throughout the design and manufacturing and inspection process. This solid model embodies all aspects of Design Intent, and specifically the geometric metadata associated with this model is what is useful for a direct validation and verification of Design Intent by comparison to individual layer data as derived by the geometric feature extraction process.

The sum total of means, systems, processes, procedures, and methods described in this present invention are capable of functioning under a wide range of illumination conditions including the low contrast conditions often found between the sintered metal and the powder bed.

The sum total of means, systems, processes, procedures, and methods described in this present invention are capable of providing objective evidence of compliance to Design Intent as described and as taught in FIG. 1 and in FIG. 2.

The Geometric Feature Extraction Process as defined in FIG. 5 and as further taught and expounded in FIGS. 6-20 is perfectly general and does not rely on the specific nature of kind of algorithm applied at any given step. The specific example described is a preferred embodiment but is not the exclusive means by which this present invention may be practiced.

The sum total of means, systems, processes, procedures, and methods described in this present invention are not limited to data which is gathered by a digital camera or CCD array.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An automated additive manufacturing apparatus for producing a part on a powder bed, the automated manufacturing apparatus comprising:
a heat source configured to apply energy to deposited layers of powder arranged on the powder bed;
an image capture device configured to periodically capture layer images of deposited layers of powder on the powder bed; and
a processor configured to apply image processing to each layer image to extract geometric features of the part for each layer, and to compare the geometric features to baseline data that includes tolerances associated with the extracted geometric features,
wherein the heat source applies energy by scanning across each deposited layer of powder in a pattern defined by the processor that corresponds to a geometry of the part.

2. The automated additive manufacturing apparatus as recited in claim 1 wherein the processor is further configured to determine dimensions of each pixel in the layer images by analyzing a flat field image taken by the image capture device that includes a calibration target positioned on the powder bed.

3. The automated additive manufacturing apparatus as recited in claim 2 wherein the processor is further configured to utilize the flat field image as a baseline image that helps distinguish sintered powder from powder that has not been sintered.

4. The automated additive manufacturing apparatus as recited in claim 1 further comprising:
a first optical sensor configured to determine a temperature associated with a fixed portion of the deposited layer of powder; and
a second optical sensor configured to receive light emitted by a portion of the deposited layer of powder being melted by the energy from the heat source.

5. The automated additive manufacturing apparatus as recited in claim 4 wherein the processor is configured to use temperature data collected by the first optical sensor to calibrate temperature data collected by the second optical sensor, and wherein the processor is configured to correlate deviations from the tolerances of the baseline data with the temperature data collected by the first and second optical sensors.

6. An additive manufacturing method, comprising:
capturing a baseline image of a build plate using an image capture device;
depositing a layer of metal material on the build plate;
melting a region of the layer of metal material to form a part being produced by the additive manufacturing method with a heat source that scans across the region of the layer of metal material to melt the region;
capturing a sintered layer image that includes the melted region of the layer of metal material using the image capture device;
continuing to deposit layers of metal, melt regions of each layer and capture sintered layer images until the additive manufacturing method is complete;
processing and aggregating data from the sintered layer images to extract geometric features formed by the additive manufacturing method; and
comparing the extracted geometric features of the part constructed by the additive manufacturing method with baseline data that includes design tolerances associated with the extracted geometric features to determine whether the extracted geometric features of the part meets the design tolerances.

7. The method as recited in claim 6 wherein processing the data from the sintered layer images comprises distinguishing between sintered powder and powder that has not been sintered.

8. The method as recited in claim 7 wherein processing the data from the sintered layer images further comprises performing edge detection processes configured to clearly define a transition between the sintered powder and the powder that has not been sintered.

9. The method as recited in claim 6 further comprising:
measuring an amount of heat applied to the region of the layer of metal material while the region is being melted; and
correlating the measured heat with extracted features to identify defects in the part.

10. The method as recited in claim 9 wherein measuring an amount of heat applied to the region of the layer of metal material comprises:
monitoring an amount of energy emitted by the heat source with a first optical sensor that follows a path along which the heat source scans the region to provide a first information set;
monitoring a portion of the region of the layer of metal material with a second optical sensor having a fixed field of view to provide a second information set; and
correlating data included in the second information set with data included in the first information set, wherein the data correlated from the first and second information sets was collected while the heat source passed through the fixed field of view.

11. The method as recited in claim 10 wherein the second optical sensor remains stationary throughout execution of the additive manufacturing method.

12. The method as recited in claim 10 wherein the heat source is a laser that shares the same optics as the first optical sensor.

13. The method as recited in claim 10 wherein the first sensor comprises a photodiode and the second sensor comprises a pyrometer.

14. The method as recited in claim 10 further comprising destructively analyzing the portion of the region monitored by the second optical sensor to determine whether a microstructure of the region monitored by the second optical sensor is consistent with the determination of the layer falling within the known-good range.

15. The method as recited in claim 14 wherein the portion of the region within the fixed field of view is separate and distinct from another portion of the region used to form the part.

16. The method as recited in claim 6 wherein the metal material comprises metal powder.

17. An additive manufacturing method for producing a part, comprising:
depositing a layer of metal powder;
sintering a portion of the layer of metal powder;
capturing an image of the sintered portion of the layer of metal powder using an image capture device;
repeating the depositing, sintering and capturing steps until the part is complete;
processing the captured images to extract geometric features corresponding to the completed part; and
comparing the extracted geometric features to baseline data to determine whether the extracted geometric features fall within design specifications for the part.

18. The additive manufacturing method as recited in claim 17 wherein processing the captured images is performed throughout the additive manufacturing method.

19. The additive manufacturing method as recited in claim 18 further comprising halting the additive manufacturing method when one or more of the extracted geometric features fall outside of the design specifications for the part.

20. The additive manufacturing method as recited in claim 17 further comprising capturing a flat field image of a build plate upon which the powder is deposited, wherein processing the captured images comprises dividing each image of the sintered portion of the layer of metal powder by the flat field image.
